(19) United States
(12) Patent Application Publication
(10) Pub. No.: US 2014/0153187 A1
(43) Pub. Date: Jun. 5, 2014

(54) RACK-MOUNT SERVER ASSEMBLY WITH CABLE MANAGEMENT APPARATUS

(71) Applicants: Hong Fu Jin Precision Industry (ShenZhen) Co., Ltd., (US); Hon Hai Precision Industry Co., Ltd., (US)

(72) Inventors: MING-YU LIU, Shenzhen (CN); AN-GANG LIANG, Shenzhen (CN); HUNG-YI WU, New Taipei (TW)

(73) Assignees: HON HAI PRECISION INDUSTRY CO., LTD., New Taipei (TW); Hong Fu Jin Precision Industry (ShenZhen) Co., Ltd., Shenzhen (CN)

(21) Appl. No.: 13/717,721

(22) Filed: Dec. 18, 2012

(30) Foreign Application Priority Data
Dec. 5, 2012 (CN) 201210515187.X

(51) Int. Cl. H02G 3/00; G06F 1/16

(52) U.S. Cl. CPC H02G 3/00; G06F 1/16
USPC 361/679.58; 174/135

(57) ABSTRACT

A rack-mount server assembly includes a rack, server modules, and a cable management apparatus. The rack includes a support pole defining a number of through holes arrayed a row along a lengthwise direction of the support pole. The cable management apparatus includes a bracket, a number of cable binding members, and a number of cable positioning members. The bracket includes an installing plate mounted on an outer side surface of the rack adjacent to the support pole, a rear side plate, and an extending plate extending from the rear side plate. The cable binding members are attached to an outer surface of the installing plate. The cable positioning members are mounted on an outer surface of the extending plate. Cables of the server modules are extended through the through holes and are respectively clamped in the cable positioning members, and are then bound by the cable binding members.

### BACKGROUND

1. Technical Field

The present disclosure relates to a rack-mount server assembly including a cable management apparatus.

2. Description of Related Art

Conventionally, a rack-mount server assembly includes a rack, a plurality of server modules received in the rack, and a switch generally mounted on a top of the rack. Many cables are needed in a rear end of the rack for transferring signals or providing power. However, a space of the rear end of the rack is limited, and the cables may not be arranged in a orderly manner, increasing air pressure and decreasing heat dissipating efficiency.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of an exemplary embodiment of a rack-mount server assembly, wherein the rack-mount server assembly includes a cable management apparatus including a plurality of cable positioning members.

FIG. 2 is an enlarged view of the circled portion II of FIG. 1.

FIG. 3 is an enlarged view of one of the cable positioning members of FIG. 1, but viewed from another perspective.

FIG. 4 is an assembled, isometric view of the rack-mount server assembly of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

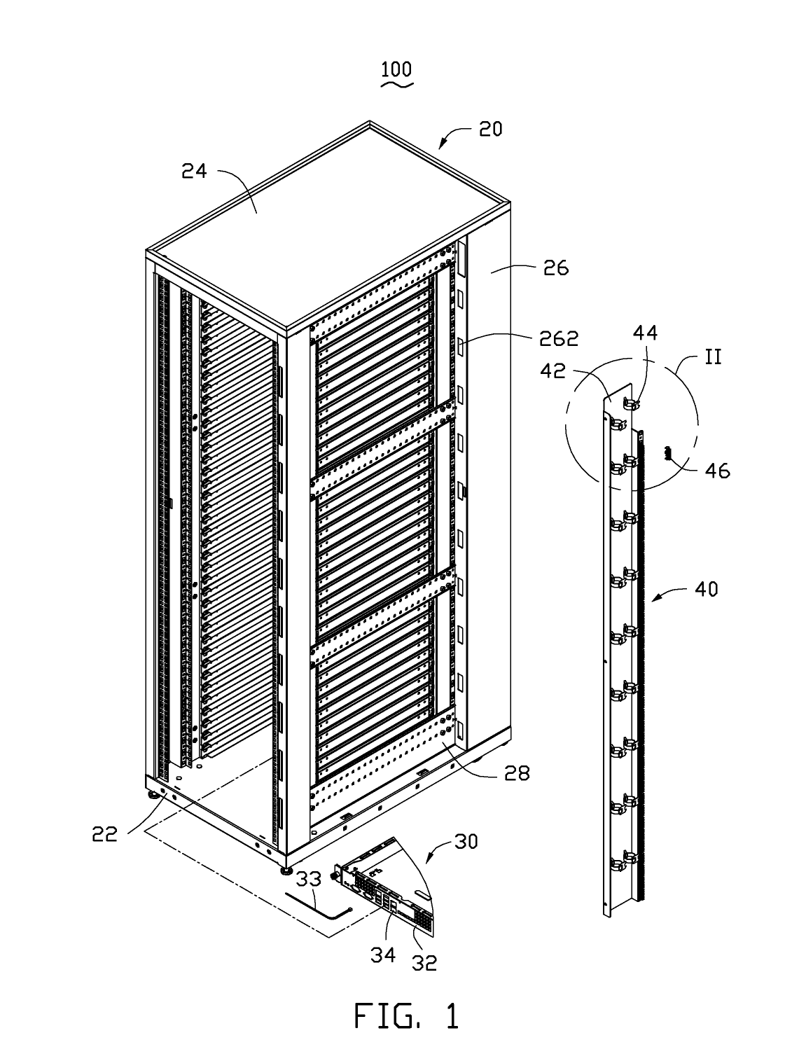

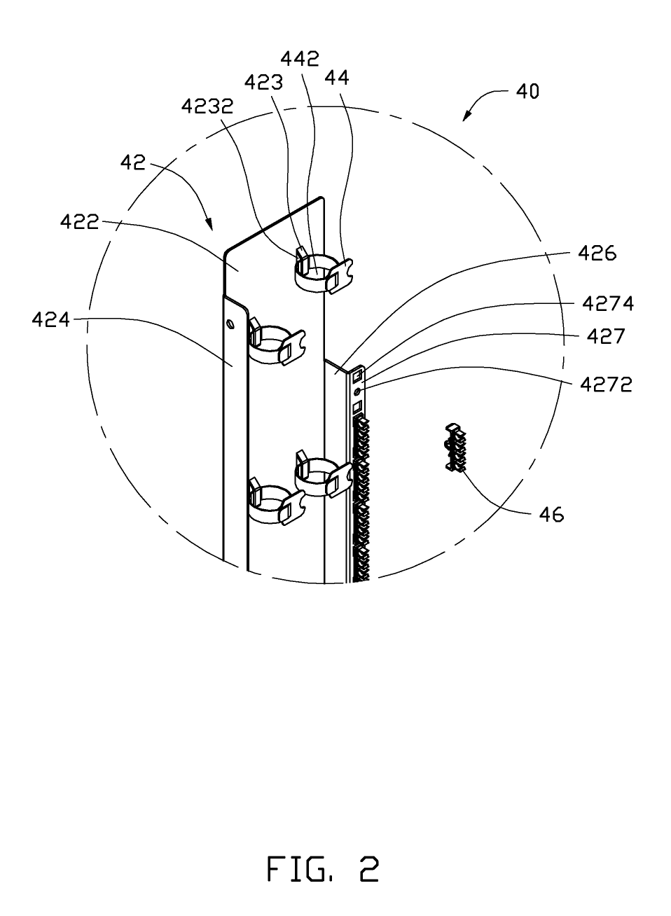

FIG. 1 and FIG. 2 show an exemplary embodiment of a rack-mount server assembly 100. The rack-mount server assembly 100 includes a rack 20, a plurality of server modules 30 received in the rack 20, and a cable management apparatus 40.

The rack 20 includes a rectangular base 22, a top wall 24 opposite to the base 22, and four support poles 26 respectively connected between four corners of the base 22 and the top wall 24. A plurality of connecting plates 28 is connected between two support poles 26 at the same side of the rack 20. One of the support poles 26 located at a rear end of the rack 20 defines a plurality of through holes 262 facing the connecting plates 28. The through holes 262 are arrayed in a row along a lengthwise direction of the support pole 26.

The server modules 30 can be inserted into the rack 20. Each server module 30 includes a rear wall 32 defining a plurality of ports 34 for receiving ends of cables 33.

The cable management apparatus 40 includes a substantially U-shaped bracket 42, a plurality of cable binding members 44, and a plurality of cable positioning members 46.

The bracket 42 includes a rectangular installing plate 422, a front side plate 424 and a rear side plate 426 perpendicularly extending out from two opposite sides of the installing plate 422 toward the same direction, and an extending plate 427 perpendicularly extending rearward from the rear side plate 426 away from the front side plate 424. The extending plate 427 defines a plurality of spaced latching holes 4272 and a plurality of position holes 4274. The lathing holes 4272 are arrayed in a row along a lengthwise direction of the extending plate 427. Two position holes 4274 are respectively locate at top side and bottom side of each latching hole 4272.

A plurality of retaining portions 423 protrudes from the installing plate 422. The retaining portions 423 are arrayed in two rows along the lengthwise direction of the installing plate 422. In an embodiment, each retaining portion 423 is bridge-shaped. A gap 4232 is defined between each retaining portion 423 and an outer surface of the installing plate 422. Each retaining portion 423 is capable of hanging one cable binding member 44. Each cable binding member 44 is strip-shaped, and can bound a holding hole 442.

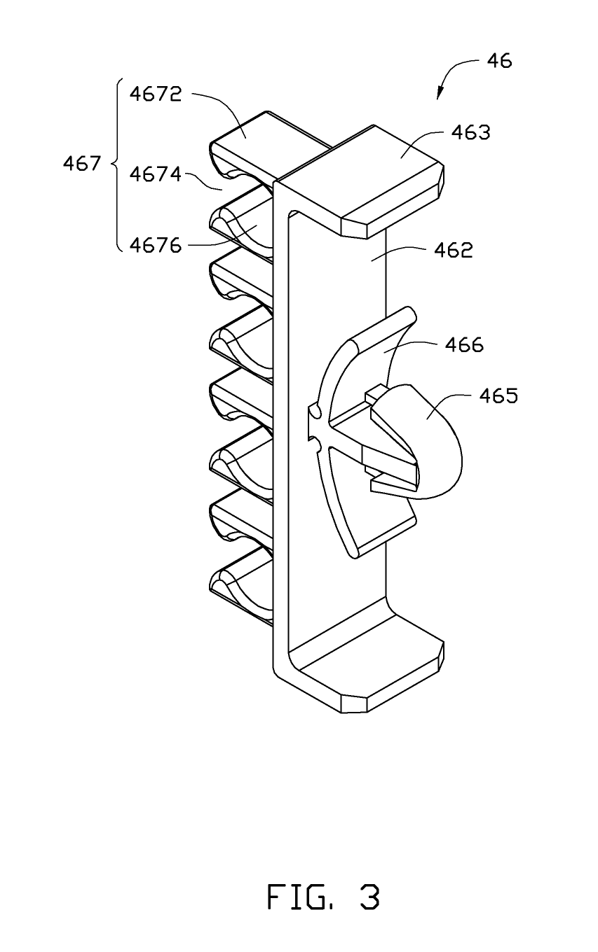

FIG. 3 shows one of the cable positioning members 46. The cable positioning member 46 includes a bar-shaped connecting plate 462, two opposite positioning pieces 463 extending from two ends of the connecting plate 462 toward the same direction. A hook 465 protruding from a middle of the connecting plate 462 along the extending direction of the positioning pieces 463, and a plurality of latching portions 467 protruding from the connecting plate 462 away from the positioning pieces 463. The latching portions 467 are arrayed in a row along the lengthwise direction of the connecting plate 462. Respectively extending out from two opposite sides of the hook 465 are two arc-shaped and resilient abutting pieces 466. Each abutting piece 466 is located between the corresponding positioning piece 463 and the hook 465. Each latching portion 467 includes two opposite resilient clamping pieces 4672. The clamping pieces 4672 of each latching portion 467 cooperatively bound a clamping slot 4676 defining an opening 4674 opposite to the connecting plate 462.

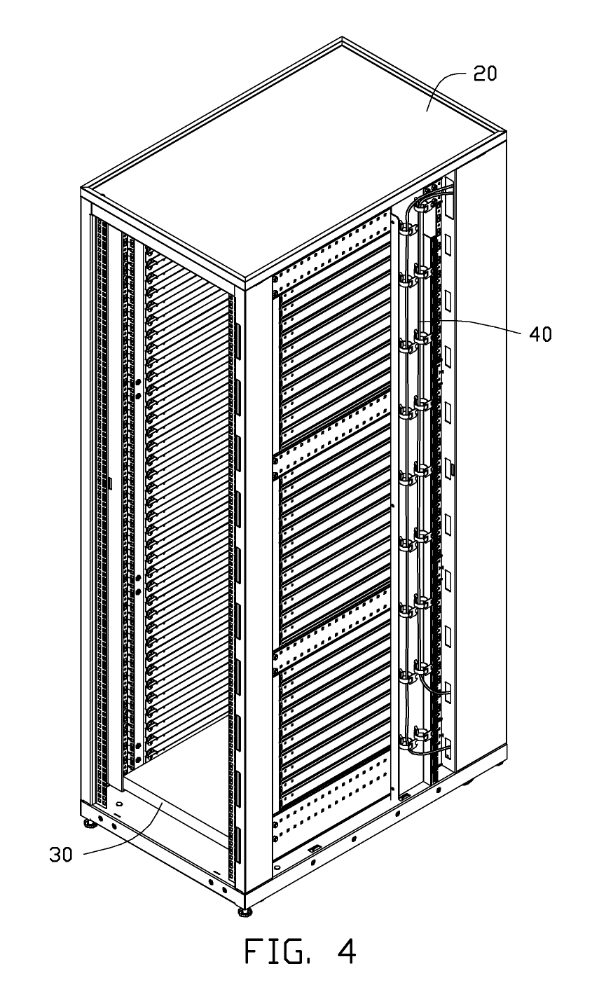

Referring to FIG. 4, in assembly, the hook 465 of each cable positioning member 46 is inserted into the corresponding latching hole 4272 of the bracket 42, to allow the positioning pieces 463 to be inserted into the corresponding position holes 4274, and the abutting pieces 466 are resiliently abutted against the extending plate 427. The bracket 42 is mounted on an outer surfaces of the connecting plates 28 adjacent and parallel to the support pole 26, to make the cable positioning members 46 face the through holes 262 of the rack 20.

In use, the server modules 30 are installed in the rack 20 from front to rear. The rear wall 32 is adjacent to the through holes 262. Ends of the cables 33 are engaged in the ports 34 of the server modules 30, the cables 33 are then extended through the adjacent through holes 262 and are respectively clamped in the clamping slots 4676 from the corresponding openings 4674. The cables 33 are respectively arranged in the holding holes 442 of the cable binding members 44. Therefore, the cables 33 can be arranged in the outer side surface of the rack 20, which does not occupy the inside space of the rack 20 and is orderly.

It is to be understood, however, that even though numerous characteristics and advantages have been set forth in the foregoing description of embodiments, together with details of the structures and functions of the embodiments, the disclosure is illustrative only and changes may be made in detail, especially in matters of shape, size, and arrangement of parts within the principles of the disclosure to the full extent indicated by the broad general meaning of the terms in which the appended claims are expressed.

What is claimed is:

1. A cable management apparatus to manage cables of a rack-mount server, the rack-mount server comprising a support pole defining a plurality of through holes arrayed a row along a lengthwise direction of the support pole, the cable management apparatus comprising:
a bracket comprising an installing plate mounted on an outer side surface of the rack adjacent to the support pole, a rear side plate extending out from a rear side of the installing plate, and an extending plate extending rearward from the rear side plate;
a plurality of cable binding members attached to an outer surface the installing plate; and
a plurality of cable positioning members arrayed on an outer surface of the extending plate and in a row along a lengthwise direction of the extending plate;
wherein, in managing the cables, the cables are extended through the through holes and are respectively clamped in the cable positioning members, and are respectively bound by the cable binding members.

2. The cable management apparatus of claim 1, wherein the installing plate is rectangular, a plurality of retaining portions protrudes from the installing plate, the retaining portions are arrayed in two rows along the lengthwise direction of the installing plate, and the cable binding members are respectively hung by the retaining portions.

3. The cable management apparatus of claim 2, wherein the extending plate defines a plurality of latching holes arrayed in a row along the lengthwise direction of the extending plate, each cable positioning member comprises a bar-shaped connecting plate, a hook protruding from the connecting plate and inserted into the corresponding latching hole, and a plurality of latching portions protruding from the connecting plate away from the hook for positioning the cables.

4. The cable management apparatus of claim 3, wherein the extending plate defines two opposite position holes located at top and bottom sides of each latching hole respectively, each cable positioning member further comprises two positioning pieces extending from two ends of the connecting plate and respectively latched into the position holes.

5. The cable management apparatus of claim 3, wherein two resilient abutting pieces respectively extending out from two opposite sides of each hook, the abutting pieces are resiliently abutted against the extending plate.

6. The cable management apparatus of claim 3, wherein each latching portion comprises two opposite resilient clamping pieces, the clamping pieces cooperatively bound a clamping slot for receiving the corresponding cable.

7. A cable management apparatus to manage cables of a rack-mount server, the rack-mount server comprising a support pole defining a plurality of through holes arrayed a row along a lengthwise direction of the support pole, the cable management apparatus comprising:
a bracket comprising an installing plate mounted on an outer side surface of the rack adjacent to the support pole, a rear side plate extending out from a rear side of the installing plate, and an extending plate extending rearward from the rear side plate; and
a plurality of cable positioning members arrayed on an outer surface of the extending plate and in a row along a lengthwise direction of the extending plate;
wherein, in managing the cables, the cables are extended through the through holes and are respectively clamped in the cable positioning members.

8. The cable management apparatus of claim 7, wherein the extending plate defines a plurality of latching holes arrayed in a row along the lengthwise direction of the extending plate, each cable positioning member comprises a bar-shaped connecting plate, a hook protruding from the connecting plate and inserted into the corresponding latching hole, and a plurality of latching portions protruding from the connecting plate away from the hook for positioning the cables.

9. The cable management apparatus of claim 8, wherein the extending plate defines two opposite position holes located at top and bottom sides of each latching hole respectively, each cable positioning member further comprises two positioning pieces extending from two ends of the connecting plate and respectively latched into the position holes.

10. The cable management apparatus of claim 8, wherein two resilient abutting pieces respectively extending out from two opposite sides of each hook, the abutting pieces are resiliently abutted against the extending plate.

11. The cable management apparatus of claim 8, wherein each latching portion comprises two opposite resilient clamping pieces, the clamping pieces cooperatively bound a clamping slot for receiving the corresponding cable.

12. A rack-mount server assembly, comprising:
a rack comprising a support pole defining a plurality of through holes arrayed a row along a lengthwise direction of the support pole;
a plurality of server modules received in the rack; and
a cable management apparatus comprising a bracket mounted on an outer side surface of the rack adjacent to the support pole, a plurality of cable binding members, and a plurality of cable positioning members;
wherein the bracket comprises an installing plate mounted to the outer side surface of the rack, a rear side plate extending out from a rear side of the installing plate, and an extending plate extending rearward from the rear side plate, the cable binding members are attached to an outer surface of the installing plate, the cable positioning members are mounted to the extending plate and arrayed in a row along a lengthwise direction of the extending plate, cables of the server modules are extended through the through holes and are respectively clamped in the cable positioning members, and then are respectively bound by the cable binding members.

13. The rack-mount server assembly of claim 12, wherein the installing plate is rectangular, a plurality of retaining portions protrudes from the installing plate, the retaining portions are arrayed in two rows along the lengthwise direction of the installing plate, and the cable binding members are respectively hung by the retaining portions.

14. The rack-mount server assembly of claim 13, wherein the extending plate defines a plurality of latching holes arrayed in a row along the lengthwise direction of the extending plate, each cable positioning member comprises a bar-shaped connecting plate, a hook protruding from the connecting plate and inserted into the corresponding latching hole, and a plurality of latching portions protruding from the connecting plate away from the hook for positioning the cables.

15. The rack-mount server assembly of claim 14, wherein the extending plate defines two opposite position holes located at top and bottom sides of each latching hole respectively, each cable positioning member further comprises two positioning pieces extending from two ends of the connecting plate and respectively latched into the position holes.

16. The rack-mount server assembly of claim 14, wherein two resilient abutting pieces respectively extending out from two opposite sides of each hook, the abutting pieces are resiliently abutted against the extending plate.

17. The rack-mount server assembly of claim 14, wherein each latching portion comprises two opposite resilient clamping pieces, the clamping pieces cooperatively bound a clamping slot for receiving the cable.
